(19) United States
(12) Patent Application Publication
(10) Pub. No.: US 2023/0281423 A1
(43) Pub. Date: Sep. 7, 2023

(54) METHOD AND SYSTEM FOR GENERATING A MIXED PRECISION MODEL

(71) Applicant: Blaize, Inc., El Dorado Hills, CA (US)

(72) Inventors: Deepak Chandra Bijalwan, Hyderabad (IN); Mounika Gude, Khammam (IN); Pratyusha Musunuru, Hyderabad (IN)

(73) Assignee: Blaize, Inc., El Dorado Hills, CA (US)

(21) Appl. No.: 18/072,785

(22) Filed: Dec. 1, 2022

Related U.S. Application Data
(60) Provisional application No. 63/316,342, filed on Mar. 3, 2022.

(51) Int. Cl. G06N 3/04; G06V 10/82; G06V 10/28

(52) U.S. Cl. CPC G06N 3/04; G06V 10/82; G06V 10/28

(57) ABSTRACT

Disclosed herein is a method and a system for generating a mixed precision quantization model for performing image processing. The method comprises receiving a validation dataset of images to train a neural network model. The method comprises for each image of the validation dataset, generating a union sensitivity list, selecting a group of layers, generating a mixed precision quantization model by quantizing the selected group of layers into a high precision format; computing accuracy of the mixed precision quantization model for comparison with a target accuracy; in response to determining the accuracy is less than the target accuracy, generating another mixed precision model by selecting a next group of layers and computing the accuracy. In response to determining the accuracy is greater than or equal to the target accuracy, storing the mixed precision quantization model as a final mixed precision quantization model for image processing.

### RELATED PATENT APPLICATIONS

This patent application claims the benefit of U.S. Provisional Patent Application Ser. No. 63/316,342, filed on Mar. 3, 2022, which is herein incorporated by reference.

### FIELD OF THE PRESENT DISCLOSURE

Embodiments of the present disclosure are related, in general to neural networks, and more particularly, but not exclusively to a method and system for quantization aware training of a neural network for image compression.

### BACKGROUND

Image compression is a widely used image processing method to compress images for quick and efficient transfer of images, videos, live streaming, space communication and other applications. Generally known methods of image compression include Joint Photographic Experts Group (JPEG). Neural networks such as convolutional neural networks, have been extensively used to compress images due to their enhanced compression artifact reduction and super-resolution performance compared with traditional computer vision models. Neural networks comprise a number of layers that are interconnected with each other. Each layer may be associated with parameters such as one or more inputs, one or more weights, one or more biases and one or more outputs of the layer.

A crucial step to achieve image compression is quantization of neural network. To provide better accuracy in compression, the neural network needs to be quantized to a high precision format for e.g., FP 16 format. However, such a high precision model may consume more time to compress the images. If the model needs to be quicker or consume less time, the neural network model needs to be quantized to a low precision format for e.g., int8 or int4 formats. However, such a low precision model may not provide enough accuracy. Hence, mixed precision models are designed to provide accuracy comparable to high precision formats and performance comparable to low precision format. Training a neural network model to a mixed precision model involves training the model layer by layer which may be time consuming as well as processor intensive.

At present, there is no such system and method that discloses efficient training and quantization of a neural network model that also consumes less time.

Thus, there is a need for a system and method to provide efficient training and quantization of the neural network model which is less time consuming to generate a mixed precision model that provides accuracy and performance.

The information disclosed in this background of the present disclosure section is only for enhancement of understanding of the general background of the present disclosure and should not be taken as an acknowledgement or any form of suggestion that this information forms prior art already known to a person skilled in the art.

### SUMMARY

Embodiments of the present disclosure relates to a method for generating a mixed precision quantization model for performing image processing. The method comprises receiving a validation dataset of images as input for quantization aware training of a neural network model comprising a plurality of layers in a low precision format. The method comprises for each image of the validation dataset, providing the image as an input to train the neural network model and generating a union sensitivity list based on sensitivity values evaluated for the plurality of layers. The method comprises selecting a group of layers, of the neural network model, corresponding to a first set of sensitivity values of the union sensitivity list and generating a mixed precision quantization model by quantizing the selected group of layers into a high precision format. The method comprises computing accuracy of the mixed precision quantization model for comparison with a target accuracy. The method comprises in response to determining that the accuracy of the mixed precision model is less than the target accuracy, selecting a next group of layers corresponding to a next set of sensitivity values, generating a mixed precision quantization model by quantizing the selected group of layers into a high precision format and computing accuracy. The method comprises in response to determining that the accuracy of the mixed precision model is greater than or equal to the target accuracy, storing the mixed precision quantization model as a final mixed precision quantization model for image processing.

Embodiments of the present disclosure relates to a system for generating a mixed precision quantization model for performing image processing. The system comprises a memory and a processor that is coupled to the memory. The processor is configured to receive a validation dataset of images as input for quantization aware training of a neural network model comprising a plurality of layers in a low precision format. The processor is configured to provide for each image of the validation dataset, the image as an input to train the neural network model and generate a union sensitivity list based on sensitivity values evaluated for the plurality of layers. The processor is configured to select a group of layers, of the neural network model, corresponding to a first set of sensitivity values of the union sensitivity list and generate a mixed precision quantization model by quantizing the selected group of layers into a high precision format. The processor is configured to compute accuracy of the mixed precision quantization model for comparison with a target accuracy. The processor is configured to select, in response to determining that the accuracy of the mixed precision model is less than the target accuracy, a next group of layers corresponding to a next set of sensitivity values, generate a mixed precision quantization model by quantizing the selected group of layers into a high precision format and computing accuracy The processor is configured to store, in response to determining that the accuracy of the mixed precision model is greater than or equal to the target accuracy, the mixed precision quantization model as a final mixed precision quantization model for image processing.

### BRIEF DESCRIPTION OF DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1 illustrates an exemplary architecture of a proposed system to generate a mixed precision quantization model;

FIG. 2 illustrates an exemplary block diagram of mixed precision quantization system (MPQS) of the FIG. 1 in accordance with some embodiments of the present disclosure;

FIG. 3 illustrates a flowchart showing a method for generating a mixed precision quantization model in accordance with some embodiments of the present disclosure;

FIGS. 4a-4b illustrates a flowchart showing a method for generating a union sensitivity list and an example of the union sensitivity list in accordance with some embodiments of the present disclosure;

FIG. 5 illustrates a flowchart showing a method for clustering layers into groups in accordance with some embodiments of the present disclosure;

FIG. 6 illustrates a flow chart showing a method for quantizing a group of layers in accordance with some embodiments of the present disclosure;

FIG. 7 illustrates a flowchart showing a method for generating a mixed precision quantization model in accordance with some embodiments of the present disclosure;

FIG. 8 illustrates a flow chart showing a method for quantizing a group of layers in accordance with some embodiments of the present disclosure; and

FIG. 9 illustrates a block diagram of an exemplary computer system for implementing embodiments consistent with the present disclosure.

The figures depict embodiments of the present disclosure for purposes of illustration only. One skilled in the art will readily recognize from the following description that alternative embodiments of the structures and methods illustrated herein may be employed without departing from the principles of the present disclosure described herein.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the present disclosure is susceptible to various modifications and alternative forms, specific embodiment thereof has been shown by way of example in the drawings and will be described in detail below. It should be understood, however that it is not intended to limit the present disclosure to the particular forms disclosed, but on the contrary, the present disclosure is to cover all modifications, equivalents, and alternative falling within the spirit and the scope of the present disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

A neural network is based on a collection of connected units or nodes called artificial neurons. Each connection, like the synapses in a biological brain, can transmit a signal to other neurons. An artificial neuron receives signals, processes them and signals neurons connected to it. The “signal” at a connection is a real number, and the output of each neuron is computed by any non-linear function of the sum of its inputs. The connections are called edges. Neurons and edges may have a weight that adjusts as learning proceeds. The weight increases or decreases the strength of the signal at a connection. Typically, neurons are aggregated into layers. Different layers may perform different transformations on their inputs. Signals travel from a first layer (input layer), to a final layer (output layer), possibly after traversing the intermediate layers multiple times.

Embodiments of the present disclosure relates to an efficient method of quantization aware training of a neural network model by quantizing a group of layers in a single iteration and validating the model. Further, the present disclosure also provides an efficient method of grouping the layers based on their sensitivity values and quantizes the group of layers that correspond to highest sensitivity first to achieve the target accuracy. The present disclosure also achieves the target accuracy in less time by quantizing the group of layers that corresponding to high sensitivity first and less sensitivity later. Thus, the present disclosure reduces or limits the training time of the neural network model by quantizing only those layers that contribute to more loss or that are more sensitive and that contribute significant improvement in accuracy and ignoring quantization of those layers that provide negligible improvement in accuracy.

In the following detailed description of the embodiments of the present disclosure, reference is made to the accompanying drawings that form a part hereof, and in which are shown by way of illustration specific embodiments in which the present disclosure may be practiced. These embodiments are described in sufficient detail to enable those skilled in the art to practice the present disclosure, and it is to be understood that other embodiments may be utilized and that changes may be made without departing from the scope of the present disclosure. The following description is, therefore, not to be taken in a limiting sense.

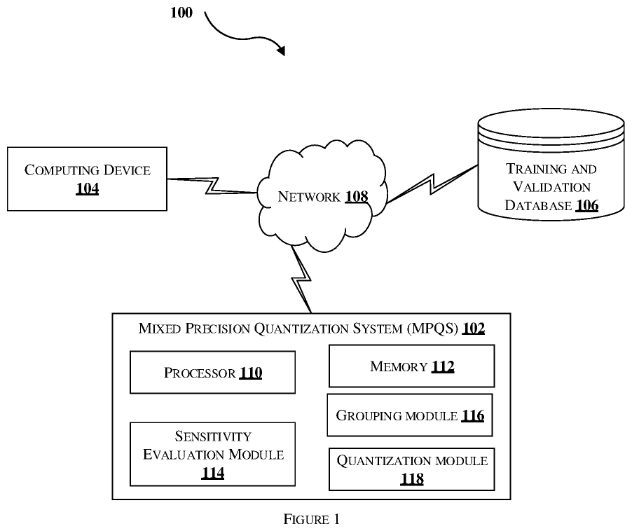

FIG. 1 illustrates an exemplary architecture of a proposed system to generate a mixed precision model for performing image processing in accordance with some embodiments of the present disclosure.

As shown in FIG. 1, the exemplary system 100 comprises one or more components configured for generating a mixed precision quantization model. In one embodiment, the system 100 comprises a mixed precision quantization system (MPQS) 102, at least one device such as a computing device 104, and a training and validation database 106 communicatively coupled via a communication network 108.

The communication network 108 may include, without limitation, a direct interconnection, LAN (local area network), WAN (wide area network), wireless network, point-to-point network, or another configuration. One of the most common types of network in current use is a TCP/IP (Transfer Control Protocol and Internet Protocol) network for communication between database client and database server. Other common Internet protocols used for such communication include HTTPS, FTP, AFS, and WAP and other secure communication protocols etc., for enabling communication with MPQS 102, and the training and validation database 106.

The training and validation database 106 stores a plurality of set of images required to train any neural network model by providing the plurality of set of images to the model as input for training the neural network model.

The computing device 104 may be any electronic computing device such as a laptop device, a desktop device, a mobile device, any other device which comprises a processor to execute the method disclosed herein. The computing device 104 may be configured to generate a mixed precision quantization model for performing image processing according to methods as disclosed herein. In some embodiments, the computing device may be configured with MPQS 102 to perform the proposed method.

The MPQS 102 comprises a processor 110, a memory 112 and one or more modules configured to generate an efficient mixed precision model for performing image processing such as image compression. In one embodiment, the one or more modules include a sensitivity evaluation module 114, a grouping module 116, and a quantization module 118. The MPQS 102 is configured to train a neural network model using quantization aware training, preferably mixed precision quantization. The MPQS 102 is further configured to generate a mixed precision model that provides reduced training time comparable to a low precision model as well as target accuracy and better precision comparable to a high precision model. Therefore, the MPQS 102 provides an efficient system that improves accuracy of a trained neural network model and improves image compression rate compared to a high precision model. For example, the MPQS 102 may receive an image and may generate an efficient mixed precision model to provide a compressed image that has better precision compared to a compressed image generated by normal compression models and reduces memory consumption.

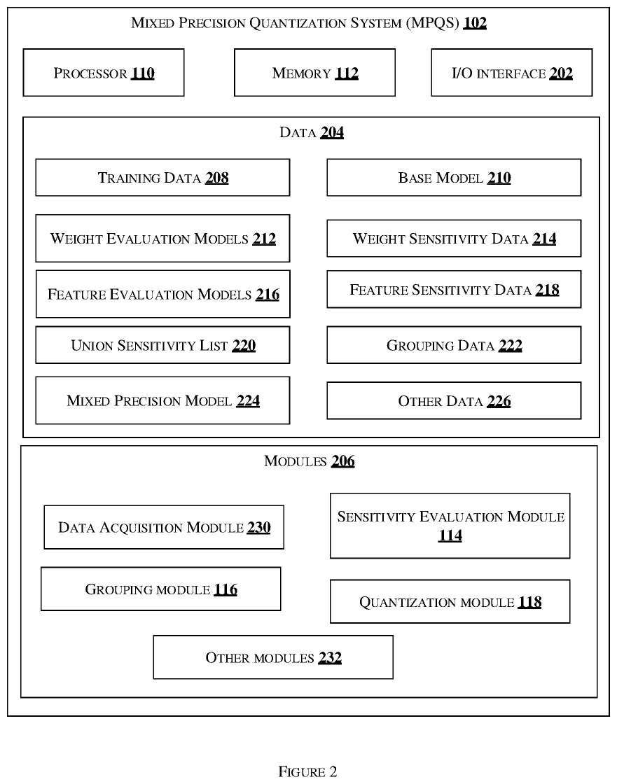

In an embodiment, the MPQS 102 may be a typical MPQS as illustrated in FIG. 2. The MPQS 102 comprises the processor 110, the memory 112, and an I/O interface 202. The I/O interface 202 is coupled with the processor 110 and an I/O device (not shown). The I/O device is configured to enable the processor 110 to communicate with and control from various I/O devices. The I/O device is configured to receive input via the I/O interface 202 and transmit output via the I/O interface 202. The MPQS 102 further includes data 204 and one or more modules 206. In one implementation, data 204 may be stored within the memory 112. In one example, the data 204 may include training data 208, base model 210, weight evaluation models 212, weight sensitivity data 214, feature evaluation models 216, feature sensitivity data 218, union sensitivity list 220, grouping data 222, mixed precision model 224 and other data 226. In some embodiments, the data 204 may be stored within the memory 112 in the form of various data structures. Additionally, the data 204 may be organized using data models, such as relational or hierarchical data models. The other data 226 may store temporary data and temporary files, generated by the components for performing the various functions of the MPQS 102.

The modules 206 comprise a data acquisition module 230, the sensitivity evaluation module 114, the grouping module 116, the quantization module 118 and other modules 232. The modules 206 may be implemented using hardware, software, or firmware. In some embodiments, the one or more modules may be configured within the processor 110. In these embodiments, any method performed by the modules 206 may also be performed by the processor 110.

In one embodiment, the data acquisition module 230 may receive data from a user to train a neural network model, also referred herein as an untrained neural network model or an input neural network model. The data acquisition module 230 may receive information about the neural network model such as number of layers in the neural network model, one or more parameters such as, but not limited to, inputs, weights, biases, activation functions, outputs associated with each layer. The data may be related to one or more target parameters to be achieved by the neural network model such as, but not limited to, a target accuracy, and a target performance metric. The data may also be related to a precision format such as, but not limited to, high precision format, low precision format and lower precision format. In one embodiment, high precision format may be 16-bit floating point representation (fp16), low precision format may be 8-bit integer representation (int8) and lower precision format may be 4-bit integer representation (int4). In another embodiment, the high precision format may be 32-bit floating point representation (fp32). The data acquisition module 230 may also acquire training data from known databases to quantize and train a neural network model to generate a mixed precision quantization model. The data acquisition module 230 may store the acquired training data as training data 208. In some embodiments, the data acquisition module 230 may also acquire validation data from databases and store them as training data 208.

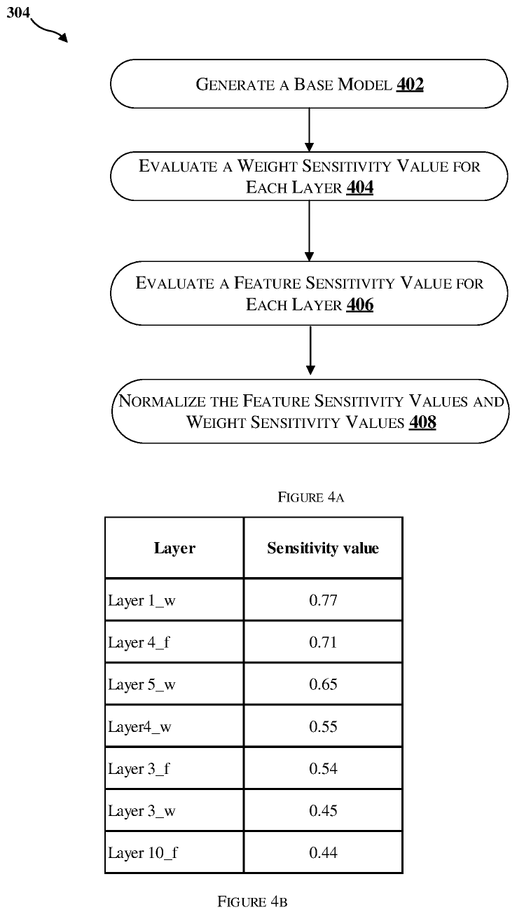

The sensitivity evaluation module 114 receives data from the data acquisition module 230 and generates a union sensitivity list. In one embodiment, the sensitivity evaluation module 114 generates a base model from the input neural network model by representing the parameters of the input neural network model in high precision format and stores as base model 210. The sensitivity evaluation module 114 also generates a plurality of weight evaluation models 212 for each layer of the input neural network model to evaluate a weight sensitivity value. The sensitivity evaluation module 114 generates a plurality of feature evaluation models 216 for each layer of the input neural network to evaluate a feature sensitivity value. The sensitivity evaluation module generates a union sensitivity list 220 based on the weight sensitivity values and feature sensitivity values evaluated for each layer of the input neural network model. A detailed explanation of the evaluation of union sensitivity list 220 has been explained further below with the help of FIGS. 4a-4b.

The grouping module 116 may cluster the plurality of layers within the input neural network model into a plurality of groups based on the union sensitivity list. In one embodiment, the grouping module 116 clusters the plurality of layers into a plurality of groups to quantize each group into a high precision format. In another embodiment, the grouping module 116 clusters the plurality of layers into another plurality of groups to quantize each group into a lower precision format.

The quantization module 118 quantizes each group of layers selected by the grouping module 116 into high precision and/or lower precision format to generate a final mixed precision model. Quantization of a neural network model includes converting a first precision format, such as high precision format, of one or more parameters associated with one or more layers of the neural network model into a second precision format such as a low precision format. For example, a neural network model may be quantized from a 32-bit floating point representation of parameters to 8-bit integer representation. Quantization of the neural network model may be performed using two techniques—Post-training quantization and Quantization-aware training. Post-training quantization is a technique in which the neural network is trained using floating-point computation and then quantized after the training. Quantization-aware training generates a quantized version of the neural network in a forward pass and parallelly trains the neural network using the quantized version. Methods in the present disclosure preferably employ Quantization-aware training technique.

The quantization module 118 may receive each group of layers selected by the grouping module 116 and may generate a temporary mixed precision model, also referred as temporary model. The quantization module 118 may make a forward pass of the temporary model and may calculate an accuracy of the temporary model. The quantization module 118 may compare the calculated accuracy of the temporary model with a known target accuracy. The quantization module 118 may retain the quantization if the quantization results in significant improvement to achieve target accuracy. The quantization module 118 may reject the quantization if the quantization does not result in significant accuracy improvement. The quantization module 118 may store the received mixed precision model as a final mixed precision quantization model.

Other modules 232 may perform other temporary operations of the method such as storing and updating the mixed precision quantization model.

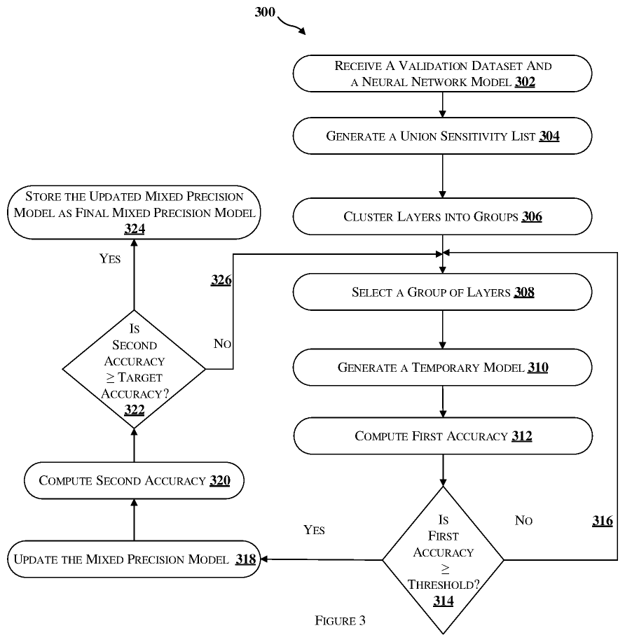

Thus, in operation, the MPQS 102 may generate the final mixed precision model that achieves the target accuracy specified by the user. In another operation, the MPQS 102 may generate the final mixed precision model that achieves the target performance metric specified by the user. A detailed explanation of generating the final mixed precision model is described below with the help of FIGS. 3-8.

FIG. 3 illustrates a flowchart showing a method for generating a final mixed precision model that achieves a target accuracy in accordance with some embodiments of the present disclosure.

As illustrated in FIG. 3, the method 300 comprises one or more blocks implemented by the processor 110 to generate the final mixed precision model by using MPQS 102. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 302, the data acquisition module 230 receives a validation dataset of images to train and validate the input neural network model. The data acquisition module 230 may receive the validation dataset from the training and validation database 106 which is in communication with the MPQS through the communication network 108. In one embodiment, the validation dataset may be an optimal dataset comprising 2% of the entire validation dataset to reduce time taken for forward passes. In this embodiment, the optimal dataset is chosen from the validation dataset through clustering of feature vectors of the plurality of layers and sampling centres and outliers of the clusters.

At block 304, the sensitivity evaluation module 114 may generate a union sensitivity list for each layer of the input neutral network model. The sensitivity evaluation module 114 receives data from the data acquisition module 230 and generates a union sensitivity list. The sensitivity evaluation module 114 generates a base model from the input neural network model by representing the parameters of the input neural network model in high precision format and stores as base model 210. The sensitivity evaluation module 114 also generates a plurality of weight evaluation models 212 for each layer of the input neural network to evaluate a weight sensitivity value. The sensitivity evaluation module 114 generates a plurality of feature evaluation models 216 for each layer of the input neural network to evaluate a feature sensitivity value. The sensitivity evaluation module generates a union sensitivity list 220 based on the weight sensitivity values and feature sensitivity values evaluated for each layer of the input neural network model. A detailed explanation of the generation of union sensitivity list 220 has been explained further below with the help of FIGS. 4a and 4b.

FIGS. 4a-4b illustrate a flowchart showing a method for generating a union sensitivity list as shown in step 304 of FIG. 3 in accordance with some embodiments of the present disclosure.

As illustrated in FIGS. 4a-4b, the method 304 comprises one or more blocks implemented by the processor 110 to generate the union sensitivity list by the sensitivity evaluation module 114. The method 304 may be described in the general context of computer executable instructions. Generally, computer executable instructions can include routines, programs, objects, components, data structures, procedures, modules, and functions, which perform specific functions or implement specific abstract data types.

The order in which the method 304 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 402, the sensitivity evaluation module 114 receives the neural network model and generates a base model by quantizing all the parameters of the neural network model into high precision format for e.g., fp16 format.

At block 404, the sensitivity evaluation module 114 evaluates a weight sensitivity value for each parametric layer. The sensitivity evaluation module 114 generates the first weight evaluation model and the second evaluation model and stores them as the weight evaluation models 212 for the layer. The sensitivity evaluation module 114 compares outputs of the first weight evaluation model and the second weight evaluation model with the base model to compute a first and a second weight sensitivity values respectively. The sensitivity evaluation module 114 determines a mean of the first and second weight sensitivity values as the weight sensitivity value of the parametric layer and stores the weight sensitivity value in the weight sensitivity data 214.

The sensitivity evaluation module 114 generates the first weight evaluation model by representing weights of the parametric layer of the base model in low precision format such as, but not limited to, int8 format and retains all the other parameters in the high precision format. The sensitivity evaluation module 114 generates the second weight evaluation model by representing weights of all previous layers to the parametric layer, of the base model, in low precision format. The sensitivity evaluation module 114 calculates a first output of a final layer of the first weight evaluation model and a second output of a final layer of the second weight evaluation model. The sensitivity evaluation module 114 calculates a base model weight output of a final layer of the base model. The sensitivity evaluation module 114 calculates a first difference metric between the first weight output and the base model weight output and a second difference metric between the second weight output and the base model weight output. In one embodiment, the difference metric may be calculated using a Jacobian determinant standard deviation method. The sensitivity evaluation module 114 evaluates a mean of the first difference metric and the second difference metric and stores the value as the weight sensitivity value of the layer.

At block 406, the sensitivity evaluation module 114 evaluates a feature sensitivity value for each parametric layer. The sensitivity evaluation module 114 generates the first feature evaluation model and the second evaluation model and stores them as the feature evaluation models 216 for the layer. The sensitivity evaluation module 114 compares outputs of the first feature evaluation model and the second feature evaluation model with the base model to compute a first and a second feature sensitivity values respectively. The sensitivity evaluation module 114 determines a mean of the first and second feature sensitivity values as the feature sensitivity value of the parametric layer and stores the feature sensitivity value in the feature sensitivity data 218.

The sensitivity evaluation module 114 determines one or more layers present between the parametric layer and a previous parametric layer of the base model. The sensitivity evaluation module 114 generates the first feature evaluation model by representing weights and features of the one or more layers in low precision format and retains all the other parameters in the high precision format. The sensitivity evaluation module 114 generates the second feature evaluation model by representing features and weights of all previous layers to the parametric layer, of the base model, in low precision format. The sensitivity evaluation module 114 calculates a first feature output of the parametric layer of the first feature evaluation model and a second feature output of the parametric layer of the second feature evaluation model. The sensitivity evaluation module 114 calculates a base model feature output of the parametric layer of the base model. The sensitivity evaluation module 114 calculates a first difference metric between the first feature output and the base model feature output and a second difference metric between the second feature output and the base model feature output. The sensitivity evaluation module 114 evaluates a mean of the first difference metric and the second difference metric and stores the value as the feature sensitivity value of the layer.

At block 408, the sensitivity evaluation module 114 normalizes the features sensitivity values and the weight sensitivity values of the plurality of layers independently and combines the sensitivity values into a union sensitivity list as illustrated in FIG. 4b. FIG. 4b illustrates a union sensitivity list of normalized sensitivity values sorted in descending order. The first row of the union sensitivity list illustrates that a weight sensitivity value corresponding to layer 1 indicated by “Layer_1_w” is 0.77. Similarly, the second row of the union sensitivity list illustrates that a feature sensitivity value of layer 4 indicated by “Layer 4_f” is 0.71. Thus, the union sensitivity list stores weight sensitivity values and feature sensitivity values of the plurality of layers of the mixed precision model in a sorted order that are evaluated by the methods described above.

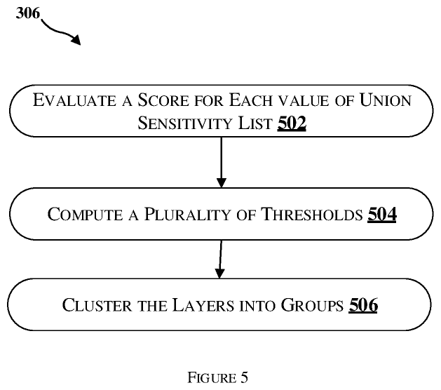

Referring to block 306 of FIG. 3, the grouping module 116 may cluster the plurality of layers within the neural network model into a plurality of groups based on the union sensitivity list. In one embodiment, the grouping module 116 clusters the plurality of layers into a plurality of groups to quantize each group into a high precision format. In another embodiment, the grouping module 116 clusters the plurality of layers into another plurality of groups to quantize each group into a lower precision format. A more detailed explanation of clustering the layers into groups is explained with the help of FIG. 5 below.

FIG. 5 illustrate a flowchart showing a method for clustering layers into a plurality of groups based on the union sensitivity list as shown in step 306 of FIG. 3 in accordance with some embodiments of the present disclosure.

As illustrated in FIG. 5, the method 306 comprises one or more blocks implemented by the processor 110 to cluster layers into a plurality of groups based on the union sensitivity list by using the grouping module 116. The method 306 may be described in the general context of computer executable instructions. Generally, computer executable instructions can include routines, programs, objects, components, data structures, procedures, modules, and functions, which perform specific functions or implement specific abstract data types.

The order in which the method 306 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 502, the grouping module 116 evaluates a score for each sensitivity value of the union sensitivity list. In one example, the grouping module 116 evaluates the score using a Z-score method.

At block 504, the grouping module 116 computes a standard deviation based on the scores and a plurality of thresholds based on the standard deviation to cluster the layers into groups. The grouping module 116 computes a first threshold which is three times of a standard deviation of the scores, a second threshold which is 2.5 times of the standard deviation and a third threshold which is two times of the standard deviation. In one embodiment, the grouping module 116 computes a fourth threshold which is a negative value of the first threshold, a fifth threshold which is a negative value of the second threshold and a sixth threshold which is a negative value of the third threshold.

At block 506, the grouping module 116 clusters the layers into groups based on the plurality of thresholds computed at block 504. The grouping module 116 clusters first set of sensitivity values associated with scores of greater than or equal to the first threshold into a first group. The grouping module 116 clusters a second set of sensitivity values associated with scores of greater than the second threshold and less than the first threshold into a second group. The grouping module 116 clusters a third set of sensitivity values associated with scores of greater than the third threshold and less than the second threshold into a third group. The grouping module 116 clusters the remaining set of sensitivity values into a fourth group. For example, from the union sensitivity list of FIG. 4b, if the standard deviation is 0.6, the grouping module groups the sensitivity values 0.77, 0.71 and 0.65 into the first group.

Referring to block 308 of FIG. 3, the quantization module 118 receives the groups from the grouping module 116 and selects each group to generate the mixed precision model. The quantization module 118 selects the first group in a first iteration, the second group in a second iteration and the third group in a third iteration. Further, the quantization module 118 identifies layers corresponding to each sensitivity value, that has not been grouped into the first, second and third groups, independently. Thus, the quantization module 118 identifies a group of layers corresponding to the selected group of sensitivity values. In the above example, the quantization module 118 identifies the layers corresponding to the first group as Layers 1, 4 and 5 from the first column of the union sensitivity list.

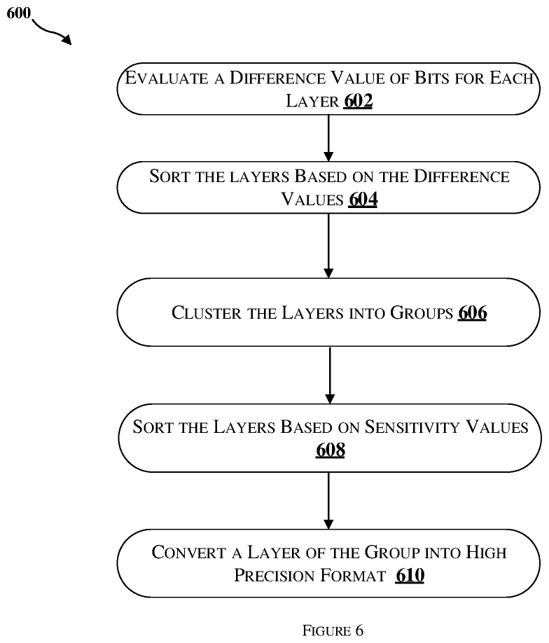

At step 310, the quantization module 118 receives the selected group of sensitivity values and determines whether the sensitivity value corresponds to a weight sensitivity value or a feature sensitivity value. For example, the quantization module 118 determines that the first sensitivity value 0.77 corresponds to weight sensitivity value of layer 1 from the last letter of the name stored in the first column i.e., “w”, the second sensitivity value 0.71 corresponds to feature sensitivity value of layer 4 from the letter “f” and the third sensitivity value 0.65 corresponds to weight sensitivity value of layer 5 from the letter “w”. If the quantization module 118 determines that the sensitivity value corresponds to a weight sensitivity value of a layer, the quantization module 118 quantizes a weight and an input of the layer into high precision format. If the quantization module 118 determines that the sensitivity value corresponds to a feature sensitivity value of a parametric layer, the quantization module 118 quantizes parameters of all the layers present between a previous parametric layer to the parametric layer to high precision format. Thus, the quantization module 118 generates a temporary model by quantizing all the layers corresponding to the selected group into high precision based on the type of sensitivity value. The quantization module 118 quantizes the layers corresponding to the sensitivity values that have not been grouped according to a method described in FIG. 6 below.

At block 312, the quantization module may make a forward pass of the temporary model and may compute a first accuracy of the temporary model. The first accuracy indicates a level of accuracy achieved by quantizing the selected group of layers into high precision format.

At block 314, the quantization module 118 may compare the first accuracy of the temporary model with a predefined threshold. In one embodiment, the data acquisition module 230 may receive the predefined threshold from the user. The predefined threshold indicates a minimum level of accuracy to be provided by any group of layers to consider the quantization of the group of layers in the mixed precision model. In other embodiment, the predefined threshold may indicate a significant contribution of accuracy improvement by quantizing a group of layers. In one example, the threshold may be a percentage of the target accuracy, such as 20% of the target accuracy.

At step 316, in response to the first accuracy is less than the threshold, the quantization module 118 may loop back to step 308 along the NO loop and may continue to select a next group.

At block 318, in response to the first accuracy is greater than or equal to the threshold, the quantization module 118 may update the mixed precision model 224 by quantizing the selected group of layers into high precision format.

At block 320, the quantization module 118 computes a second accuracy of the updated mixed precision model 224. The second accuracy indicates an accuracy of the entire mixed precision model 224, also referred to as “accuracy” of the mixed precision model.

At block 322, the quantization module 118 compares the second accuracy with the target accuracy. If the second accuracy is greater than or equal to target accuracy, the quantization module 118 proceeds to block 324 along the YES loop. If the second accuracy is less than the target accuracy, the quantization module 118 loops back to block 308 along the NO loop and again performs quantization of a next group.

At block 324, the quantization module 118 stores the updated mixed precision model 224 as a final mixed precision model and provides the final mixed precision model as output.

Thus, the present disclosure provides an efficient method quantization aware training of a neural network model by quantizing a group of layers in a single iteration and validating the model. Further, the present disclosure also provides an efficient method of grouping the layers based on their sensitivity values and quantizes the group of layers that correspond to highest sensitivity first to achieve the target accuracy. The present disclosure also achieves the target accuracy in less time by quantizing the group of layers that corresponding to high sensitivity first and less sensitivity later. Thus, the present disclosure reduces or limits the training time of the neural network model by quantizing only those layers that contribute to more loss or that are more sensitive and that contribute significant improvement in accuracy and ignoring quantization of those layers that provide negligible improvement in accuracy.

FIG. 6 illustrate a flowchart showing a method for quantizing layers that belong to fourth group into high precision format in accordance with some embodiments of the present disclosure.

As illustrated in FIG. 6, the method 600 comprises one or more blocks implemented by the processor 110 to quantize the layers that belong to the fourth group by using the quantization module 118. The method 600 may be described in the general context of computer executable instructions. Generally, computer executable instructions can include routines, programs, objects, components, data structures, procedures, modules, and functions, which perform specific functions or implement specific abstract data types.

The order in which the method 600 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At step 602, the quantization module 118 evaluates a difference value of bits for each layer. The quantization module 118 receives a plurality of sensitivity values that are clustered into fifth group and identifies a layer corresponding to each sensitivity value. The quantization module 118 performs a per-channel quantization of each layer and evaluates number of bits required to represent each channel of the layer. Per-channel quantization (PCQ) refers to quantizing each channel of a layer independently with a unique number of quantization bits. Normally, quantization of a CNN quantizes a layer of a neural network using a single value of bits for the layer, for e.g., 8 bits. However, PCQ enhances accuracy of quantization by quantizing each channel of a layer individually with a quantization value of bits, for e.g., 4 bits for first channel, 5 bits for second channel, 8 bits for tenth channel. The quantization module 118 calculates number of bits required for each channel to provide full precision accuracy. The quantization module 118 further finds a maximum value and a minimum value of the calculated number of bits for each channel. For example, a first channel requires 2 bits for quantization, a second channel requires 9 bits for quantization and other channels require any number of bits from 3 bits to 6 bits for quantization. In this example, the quantization module 118 finds that 2 bits is a minimum value, 9 bits as a maximum value and evaluates the difference value for the layer as 9−2=7 bits. The quantization module 118 finds a difference between the maximum value and the minimum value of the number of bits for the layer and stores the value as the difference value of bits for the layer.

At step 604, the quantization module 118 sorts the layers based on the difference values, such as, but not limited to, in a descending order.

At step 606, the quantization module 118 clusters the layers into groups or clusters based on the difference values. In one embodiment, the quantization module 118 clusters the layers corresponding to a difference value into a group and clusters the layers corresponding to another difference value into another group. For example, the quantization module 118 clusters all the layers corresponding to a difference value of 7 bits into a first cluster, layers corresponding to another difference value of 6 bits into a second cluster and so on. In another embodiment, the quantization module 118 clusters the layers corresponding to difference values of a particular range into groups. For example, the quantization module 118 clusters the layers corresponding to a range difference values between 5 bits-7 bits to a first cluster, the layers corresponding to a range of difference values between 4 bits-5 bits to a second cluster and so on. In some embodiments, the user may choose the difference values to be clustered.

At step 608, the quantization module 118 sorts the layers within each cluster based on sensitivity values such as, but not limited to, a descending order of the sensitivity values. In another embodiment, the quantization module 118 sorts the layers within each cluster in an ascending order of the sensitivity values.

At step 610, the quantization module 118 quantizes a layer of each cluster into high precision format. The quantization module 118 quantizes a layer of the first cluster into high precision format to generate the temporary model at step 310 of the flow chart described in FIG. 3. Further, in a next iteration, the quantization module 118 quantizes a next layer of the first cluster into high precision format to generate the temporary model. In further iteration, the quantization module 118 quantizes a layer of the second cluster upon quantizing all the layers of the first cluster.

Thus, the present disclosure optimally quantizes the layers that correspond to highest difference values of bits first and which are sorted by sensitivity values. Thus, for example, the present disclosure quantizes a layer that has highest difference value of bits and highest sensitivity first and checks whether the quantization of the layer provides the required accuracy.

In an example, a user may provide an input neural network model for training, a threshold accuracy of 50% and a target accuracy of 90% to the system. The MPQS 102 receives the input neural network model, retrieves a dataset of nearly 100 images of different feature vectors to train the input neural network model. The MPQS 102 generates base model of the input neural network model, weight sensitivity models and feature sensitivity models as described above for each layer of the input neural network model. The MPQS 102 provides a first image among the dataset as input to the generated models, calculates sensitivity values for each layer and generates a union sensitivity list for the input neural network model. The MPQS 102 clusters layers into a number of groups using the union sensitivity list. The MPQS 102 selects a first group of layers with high sensitivity and quantizes the group into a high precision format as described above to generate a temporary model. For example, the temporary model comprises quantization of weights of layer 1 and features of layer 5 into high precision format.

The MPQS 102 makes a forward pass including the quantization within the temporary model and computes a first accuracy of the temporary model. The MPQS 102 compares the first accuracy, for e.g., 60% with the threshold accuracy i.e., 50% and retains the quantization since the first accuracy is greater than the threshold accuracy. The MPQS 102 retains the quantization of the temporary model by including the quantization of the temporary model to the input neural network model and storing it as a mixed precision model. The MPQS 102 computes a second accuracy, also called “accuracy”, of the mixed precision model with the target accuracy. If the accuracy is 65%<target accuracy 90%, the MPQS 102 proceeds to quantize a next group of layers. The MPQS generates another temporary model and computes a first accuracy of another temporary model. For e.g., another temporary model comprises quantizing weights of 6^{th} and 7^{th} layers and features of 11^{th} and 15^{th} layer into high precision format. If the first accuracy is 70%, the MPQS 102 updates the mixed precision model previously stored with the quantization of another temporary model. The MPQS 102 then computes a second accuracy for e.g., 95% and compares with target accuracy 90%. The MPQS 102 stores the updated mixed precision model as the final mixed precision model of the input neural network model.

In some embodiments, the neural network model needs to achieve the target accuracy for each image of the training dataset. In other embodiments, the neural network model needs to achieve the target accuracy for the plurality of images of the training dataset.

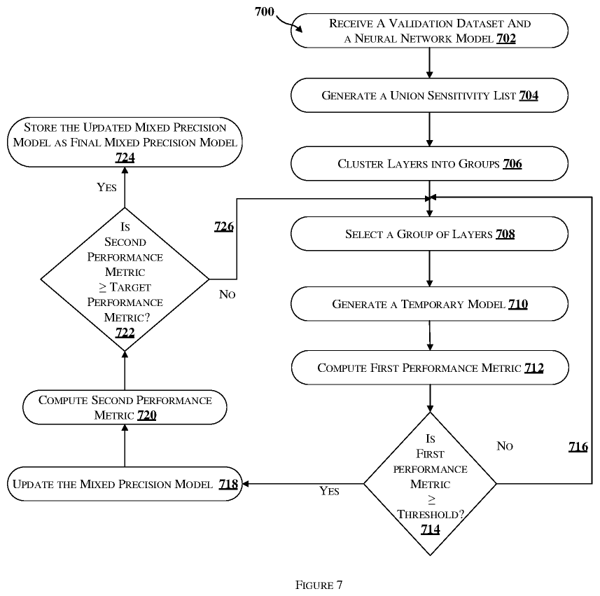

FIG. 7 illustrates a flowchart showing a method for generating a final mixed precision model that achieves a performance metric in accordance with some embodiments of the present disclosure.

As illustrated in FIG. 7, the method 700 comprises one or more blocks implemented by the processor 110 to generate the final mixed precision model by using MPQS 102 that achieves a target performance metric. The method 700 may be described in the general context of computer executable instructions. Generally, computer executable instructions can include routines, programs, objects, components, data structures, procedures, modules, and functions, which perform specific functions or implement specific abstract data types.

The order in which the method 700 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 702, the data acquisition module 230 receives a validation dataset of images to train and validate a neural network model. The data acquisition module 230 may receive the validation dataset from the training and validation database 106 which is in communication with the MPQS through the communication network 108. In one embodiment, the validation dataset may be the optimal dataset as described above.

At block 704, the sensitivity evaluation module 114 may generate a union sensitivity list for each layer of the neutral network model as described above using the method described in FIGS. 4a-4b.

At block 706, the grouping module 116 may cluster the plurality of layers within the neural network model into a plurality of groups based on the union sensitivity list as described in FIG. 5 above. However, at step 504, the grouping module 116 computes a fourth threshold which is a negative value of the first threshold, a fifth threshold which is a negative value of the second threshold and a sixth threshold which is a negative value of the third threshold. Further, at step 506, the grouping module 116 clusters the layers into groups based on the fifth, sixth and seventh thresholds. The grouping module 116 clusters a fifth set of sensitivity values associated with scores of less than or equal to the fifth threshold into a first group. The grouping module 116 clusters a sixth set of sensitivity values associated with scores of less than the sixth threshold and less than the fifth threshold into a sixth group. The grouping module 116 clusters a seventh set of sensitivity values associated with scores of less than the seventh threshold and less than the sixth threshold into a seventh group. The grouping module 116 clusters the remaining set of sensitivity values as an eighth set of sensitivity values into an eighth group.

At step 708, the quantization module 118 receives the groups from the grouping module 116 and selects each group to generate the mixed precision model. The quantization module 118 selects the fifth group in a first iteration, the sixth group in a second iteration and the seventh group in a third iteration. Thus, the quantization module 118 identifies a group of layers corresponding to the selected group of sensitivity values.

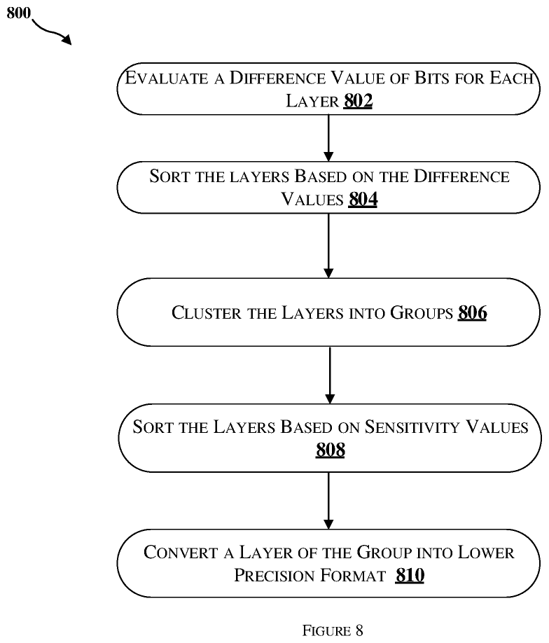

At step 710, the quantization module 118 receives the selected group of sensitivity values and determines whether the sensitivity value corresponds to a weight sensitivity value or a feature sensitivity value. If the quantization module 118 determines that the sensitivity value corresponds to a weight sensitivity value of a layer, the quantization module 118 quantizes a weight and an input of the layer into lower precision format. If the quantization module 118 determines that the sensitivity value corresponds to a feature sensitivity value of a parametric layer, the quantization module 118 quantizes parameters of all the layers present between a previous parametric layer to the parametric layer to lower precision format. Thus, the quantization module 118 generates a temporary model by quantizing all the layers corresponding to the selected group into lower precision based on the type of sensitivity value. The quantization module 118 quantizes the layers corresponding to the sensitivity values that have not been grouped according to a method described in FIG. 8 below.

At block 712, the quantization module may make a forward pass of the temporary model and may compute a first performance metric of the temporary model. The first performance metric indicates a level of performance metric achieved by quantizing the selected group of layers into lower precision format. The performance metric may be a speed of the model, an execution time taken for the model or any other metric that indicates the performance of the model.

At block 714, the quantization module 118 may compare the first performance metric of the temporary model with a predefined threshold. In one embodiment, the data acquisition module 230 may receive the predefined threshold from the user. The predefined threshold indicates a minimum level of performance metric to be provided by any group of layers to consider the quantization of the group of layers in the mixed precision model. In other embodiment, the predefined threshold may indicate a significant contribution of performance metric improvement by quantizing a group of layers. In one example, the threshold may be a percentage of the target performance metric, such as 20% of the target performance metric.

At step 716, in response to the first performance metric is less than the threshold, the quantization module 118 may loop back to step 706 and may continue to select a next group.

At block 718, in response to the first performance metric is greater than or equal to the threshold, the quantization module 118 may update the mixed precision model 224 by quantizing the selected group of layers into lower precision format.

At block 720, the quantization module 118 computes a second performance metric of the updated mixed precision model 224. The second performance metric indicates a performance metric of the entire mixed precision model 224.

At block 722, the quantization module 118 compares the second performance metric with the target performance metric. If the second performance metric is greater than or equal to target performance metric, the quantization module 118 proceeds to block 724. If the second performance metric is less than the target performance metric, the quantization module 118 loops back to block 706 and again performs quantization of a next group.

At block 724, the quantization module 118 stores the updated mixed precision model 224 as a final mixed precision model and provides the final mixed precision model as output.

The present disclosure also provides an efficient method of grouping the layers based on their sensitivity values and quantizes the group of layers that correspond to highest sensitivity first to achieve the target performance metric. The present disclosure also achieves the target performance metric in less time by quantizing the group of layers that correspond to high effect on performance and less effect on performance Thus, the present disclosure reduces or limits the training time of the neural network model by quantizing only those layers that contribute to more loss or that are more sensitive and that contribute significant improvement in performance metric and ignoring quantization of those layers that provide negligible improvement in performance metric.

FIG. 8 illustrate a flowchart showing a method for quantizing layers that belong to eighth group into high precision format in accordance with some embodiments of the present disclosure.

As illustrated in FIG. 8, the method 800 comprises one or more blocks implemented by the processor 110 to quantize the layer that does not belong to either the first, second or the third groups by using the quantization module 118. The method 800 may be described in the general context of computer executable instructions. Generally, computer executable instructions can include routines, programs, objects, components, data structures, procedures, modules, and functions, which perform specific functions or implement specific abstract data types.

The order in which the method 800 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At step 802, the quantization module 118 evaluates a difference value of bits for each layer as described in step 602 of the method described in FIG. 6.

At step 804, the quantization module 118 sorts the layers based on the difference values, such as, but not limited to, in an ascending order.

At step 806, the quantization module 118 clusters the layers into groups or clusters based on the difference values as described in step 606 of FIG. 6.

At step 808, the quantization module 118 sorts the layers within each cluster based on sensitivity values such as, but not limited to, an ascending order of the sensitivity values.

At step 810, the quantization module 118 quantizes a layer of each cluster into lower precision format. The quantization module 118 quantizes a layer of the first cluster into lower precision format to generate the temporary model at step 710 of the flow chart described in FIG. 7. Further, in a next iteration, the quantization module 118 quantizes a next layer of the first cluster into lower precision format to generate the temporary mode. In further iteration, the quantization module 118 quantizes a layer of the second cluster upon quantizing all the layers of the first cluster.

Thus, the present disclosure optimally quantizes the layers that correspond to highest difference values of bits first and which are sorted by sensitivity values. Thus, for example, the present disclosure quantizes a layer that has highest difference value of bits and highest sensitivity first and checks whether the quantization of the layer provides the target performance metric.

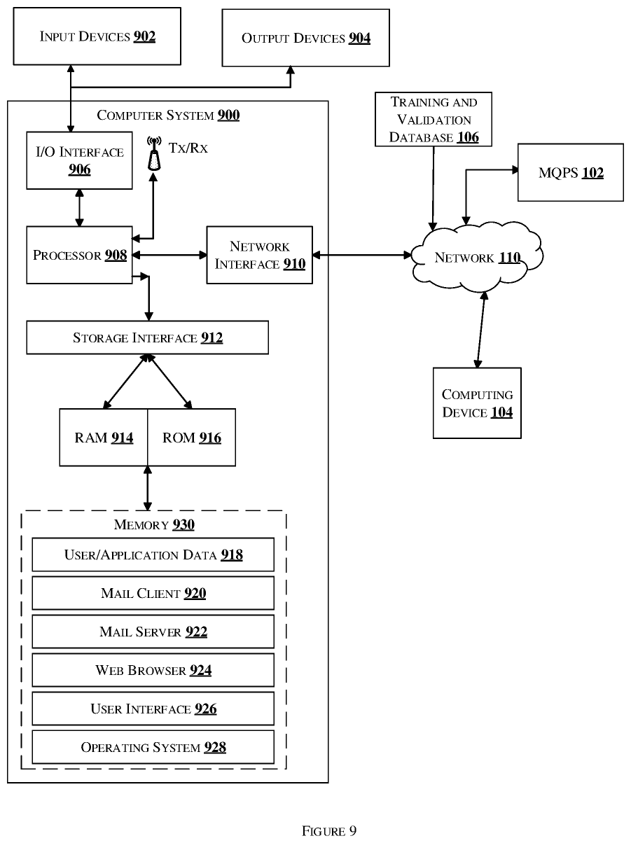

FIG. 9 illustrates a block diagram of an exemplary computer system for implementing embodiments consistent with the present disclosure.

In an embodiment, the computer system (900) may be mixed precision quantization system 102, which is used for generating a final mixed precision model that achieves a target accuracy or a target performance metric. The computer system (900) may include a central processing unit (“CPU” or “processor”) (908). The processor (908) may comprise at least one data processor for executing program components for executing user or system-generated business processes. The processor (908) may include specialized processing units such as integrated system (bus) controllers, memory management control units, floating point units, graphics processing units, digital signal processing units, etc.

The processor (908) may be disposed in communication with one or more input/output (I/O) devices (902 and 904) via I/O interface (906). The I/O interface (906) may employ communication protocols/methods such as, without limitation, audio, analog, digital, stereo, IEEE-1994, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface (906), the computer system (900) may communicate with one or more I/O devices (902 and 904). In some implementations, the processor (908) may be disposed in communication with a communication network 108 via a network interface (910). The network interface (910) may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface (910) and the communication network 108, the computer system (900) may be connected to the MPQS 102, the WHM device 104, the standards database 109, the monitoring system 108, and the prediction database 110.

The communication network 108 can be implemented as one of the several types of networks, such as intranet or any such wireless network interfaces. The communication network 108 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 108 may include a variety of network devices, including routers, bridges, servers, computing devices, storage devices, etc.

In some embodiments, the processor (908) may be disposed in communication with a memory (990) e.g., RAM (914), and ROM (916), etc. as shown in FIG. 9, via a storage interface (912). The storage interface (912) may connect to memory (990) including, without limitation, memory drives, removable disc drives, etc., employing connection protocols such as Serial Advanced Technology Attachment (SATA), Integrated Drive Electronics (IDE), IEEE-1994, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (990) may store a collection of program or database components, including, without limitation, user/application (918), an operating system (928), a web browser (924), a mail client (920), a mail server (922), a user interface (926), and the like. In some embodiments, computer system (900) may store user/application data (918), such as the data, variables, records, etc. as described in this disclosure. Such databases may be implemented as fault-tolerant, relational, scalable, secure databases such as Oracle or Sybase.

The operating system (928) may facilitate resource management and operation of the computer system (900). Examples of operating systems include, without limitation, Apple Macintosh™ OS X™, UNIX™, Unix-like system distributions (e.g., Berkeley Software Distribution (BSD), FreeBSD™, Net BSD™, Open BSD™, etc.), Linux distributions (e.g., Red Hat™, Ubuntu™, K-Ubuntu™, etc.), International Business Machines (IBM™) OS/2™, Microsoft Windows™ (XP™, Vista/7/8, etc.), Apple iOS™, Google Android™, Blackberry™ Operating System (OS), or the like. A user interface may facilitate display, execution, interaction, manipulation, or operation of program components through textual or graphical facilities. For example, user interfaces may provide computer interaction interface elements on a display system operatively connected to the computer system (900), such as cursors, icons, check boxes, menus, windows, widgets, etc. Graphical User Interfaces (GUIs) may be employed, including, without limitation, Apple™ Macintosh™ operating systems' Aqua™, IBM™ OS/2™, Microsoft™ Windows™ (e.g., Aero, Metro, etc.), Unix X-Windows™, web interface libraries (e.g., ActiveX, Java, JavaScript, AJAX, HTML, Adobe Flash, etc.), or the like.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

Finally, the language used in the specification has been principally selected for readability and instructional purposes, and it may not have been selected to delineate or circumscribe the inventive subject matter. Accordingly, the present disclosure of the embodiments of the present disclosure is intended to be illustrative, but not limiting, of the scope of the present disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

We claim:

1. A method of generating a mixed precision quantization model for performing image processing, the method comprising:
receiving, by a processor of a mixed precision quantization system, a validation dataset of images as input for quantization aware training of a neural network model comprising a plurality of layers in a low precision format;
for each image of the validation dataset,
a. providing, by the processor, the image as an input to train the neural network model;
b. generating, by the processor, a union sensitivity list based on sensitivity values evaluated for the plurality of layers;
c. selecting, by the processor, a group of layers, of the neural network model, corresponding to a first set of sensitivity values of the union sensitivity list;
d. generating, by the processor, a mixed precision quantization model by quantizing the selected group of layers into a high precision format;
e. computing, by the processor, accuracy of the mixed precision quantization model for comparison with a target accuracy;
f. in response, by the processor, to determining that the accuracy of the mixed precision model is less than the target accuracy, perform steps c to e, by selecting a next group of layers corresponding to a next set of sensitivity values; and
g. in response, by the processor, to determining that the accuracy of the mixed precision model is greater than or equal to the target accuracy, storing the mixed precision quantization model as a final mixed precision quantization model for image processing.

2. The method as claimed in claim 1, wherein generating the union sensitivity list based on sensitivity values evaluated for the plurality of layers comprises evaluating a weight sensitivity value for a parametric layer by:
generating a base model by quantizing parameters of the plurality of layers into the high precision format; and calculating an output of the base model, wherein the parameters comprise an input, a weight and an output of a layer and wherein the high precision format is a 16-bit floating point representation of data;
generating a first weight evaluation model by quantizing weights of the parametric layer of the base model into low precision format; and calculating an output of the first weight evaluation model, wherein the low precision format is an 8-bit integer representation of data;
calculating a first weight sensitivity value based on a difference between the output of the base model and the output of the first weight evaluation model;
generating a second weight evaluation model by quantizing weights of all previous layers to the parametric layer, of the base model, to low precision format;
calculating a second weight sensitivity value based on a difference between the output of the base model and the output of the second weight evaluation model; and
determining a mean of the first weight sensitivity value and the second weight sensitivity value as the weight sensitivity value of the parametric layer.

3. The method as claimed in claim 2, wherein generating the union sensitivity list based on sensitivity values evaluated for the plurality of layers further comprises evaluating a feature sensitivity value for the parametric layer by:
calculating an output of the parametric layer of the base model;
generating a first feature evaluation model by quantizing features and weights of layers, of the base model, from a previous parametric layer to the parametric layer into low precision format and calculating an output of the parametric layer of the first feature evaluation model;
calculating a first feature sensitivity value based on a difference between the output of the base model and the output of the first feature evaluation model;
generating a second feature evaluation model by quantizing weights and features of all previous layers till the parametric layer, of the base model, to low precision format;
calculating a second feature sensitivity value based on a difference between the output of the base model and the output of the second feature evaluation model; and
determining a mean of the first feature sensitivity value and the second feature sensitivity value as the feature sensitivity value of the parametric layer.

4. The method as claimed in claim 3, wherein generating the union sensitivity list based on the sensitivity values evaluated for the plurality of layers further comprising:
normalizing feature sensitivity values and weight sensitivity values corresponding to each parametric layer among the plurality of layers;
evaluating the score for each normalized value; and
generating the union sensitivity list of the scores evaluated for the normalized values;

5. The method as claimed in claim 4, wherein evaluating the score for each normalized value comprising evaluating a Z-score for each normalized value.

6. The method as claimed in claim 1, wherein selecting the group of layers corresponding to the first set of sensitivity values comprises:
clustering the sensitivity values based on the evaluated scores into a plurality of groups by:
clustering the first set of sensitivity values associated with scores of greater than or equal to a first threshold into a first group, wherein the first threshold is three times of a standard deviation of the scores;
clustering a second set of sensitivity values associated with scores of greater than a second threshold and less than the first threshold into a second group, wherein the second threshold is 2.5 times of the standard deviation;
clustering a third set of sensitivity values associated with scores of greater than a third threshold and less than the second threshold into a third group, wherein the third threshold is two times of the standard deviation; and
clustering the remaining sensitivity values as the fourth set of sensitivity values of the union sensitivity list into a fourth group.

7. The method as claimed in claim 6 further comprising:
for each sensitivity value of any of the first group, the second group, the third group,
i. determining each sensitivity value corresponds to at least one of a feature sensitivity value and a weight sensitivity value;
ii. upon determining that the sensitivity value corresponds to the weight sensitivity value of a layer, convert a weight and an input of the layer to high precision format; and
iii. upon determining that the sensitivity value corresponds to the feature sensitivity value of a layer, convert parameters of layers from a previous parametric layer to the parametric layer to high precision format.

8. The method as claimed in claim 6, further comprising, for the fourth group of sensitivity values,
determining a layer corresponding to each sensitivity value;
evaluating a difference value of bits for the plurality of parametric layers;
sorting the layers based on the difference value of bits of each layer;
cluster the layers based on the difference values into a plurality of groups;
for each group of layers, sort the layers in a descending order of the corresponding sensitivity values; and
quantizing a layer of group into high precision format and perform the steps of e-g of claim 1.

9. The method as claimed in claim 8, wherein evaluating the difference value of bits for the plurality of parametric layers comprising:
evaluating a number of bits for each channel of the parametric layer; and
determining a difference between a maximum number of bits and a minimum number of bits for the parametric layer and storing the difference as the difference value of the layer.

10. The method as claimed in claim 1, further comprising:
h. selecting a group of layers corresponding to a fourth set of sensitivity values;
i. generating another mixed precision quantization model by quantizing the selected group of layers into lower precision format;
j. computing a performance value of the another mixed precision quantization model for comparison with a target performance value;
k. in response to determining that the performance value of the another mixed precision quantization model is less than the target performance value, perform steps i to k; and
l. in response to determining that the performance value of the another mixed precision quantization model is greater than or equal to the target performance value, storing the another mixed precision quantization model as the final mixed precision quantization model for image processing.

11. The method as claimed in claim 10, wherein selecting the group of layers corresponding to the fourth set of sensitivity values comprises
clustering the sensitivity values based on the evaluated scores into another plurality of groups by:
clustering a fifth set of sensitivity values associated with scores of less than or equal to a fourth threshold into a fifth group, wherein the fourth threshold is a negative value of the first threshold;
clustering a sixth set of sensitivity values associated with scores of less than a fifth threshold and greater than the fourth threshold into a sixth group, wherein the fifth threshold is a negative value of the second threshold;
clustering a seventh set of sensitivity values associated with scores of less than a sixth threshold and greater than the fifth threshold into a seventh group, wherein the sixth threshold is a negative value of the third threshold; and
clustering the remaining sensitivity values as an eighth set of sensitivity values of the union sensitivity list into an eighth group.

12. The method as claimed in claim 11, wherein further comprising:
for each sensitivity value of any of the fifth group, the sixth group and the seventh group,
i. determining each sensitivity value corresponds to at least one of a feature sensitivity value and a weight sensitivity value;
ii. upon determining that the sensitivity value corresponds to the weight sensitivity value of a layer, convert a weight and an input of the layer to the lower precision format; and
iii. upon determining that the sensitivity value corresponds to the feature sensitivity value of a layer, convert parameters of layers from a previous parametric layer to the parametric layer to the lower precision format.

13. The method as claimed in claim 11, further comprising, for the eighth group,
determining a layer corresponding to each sensitivity value;
sorting the layers based on the difference value of bits of each layer;
cluster the layers based on the difference value of bits into a plurality of groups; for each group of layers, sort the layers in an ascending order of the corresponding sensitivity values; and
quantizing a layer of group into lower precision format and perform the steps of j to l of claim 10.

14. A system to generate a mixed precision quantization model for performing image processing comprising:
a memory;
a processor coupled with memory, that is configured to perform steps of:
receiving a validation dataset of images as input for quantization aware training of a neural network model comprising a plurality of layers in a low precision format;
for each image of the validation dataset,
a. providing the image as an input to train the neural network model;
b. generating a union sensitivity list based on sensitivity values evaluated for the plurality of layers;
c. selecting a group of layers, of the neural network model, corresponding to a first set of sensitivity values of the union sensitivity list;
d. generating a mixed precision quantization model by quantizing the selected group of layers into a high precision format;
e. computing accuracy of the mixed precision quantization model for comparison with a target accuracy;
f. in response to determining that the accuracy of the mixed precision model is less than the target accuracy, perform steps c to e, by selecting a next group of layers corresponding to a next set of sensitivity values; and
g. in response to determining that the accuracy of the mixed precision model is greater than or equal to the target accuracy, storing the mixed precision quantization model as a final mixed precision quantization model for image processing.

15. The system as claimed in claim 14, wherein for generating the union sensitivity list based on sensitivity values evaluated for the plurality of layers comprises evaluating a weight sensitivity value for a parametric layer, the processor is configured to perform the steps of:
generating a base model by quantizing parameters of the plurality of layers into the high precision format; and calculating an output of the base model, wherein the parameters comprise an input, a weight and an output of a layer and wherein the high precision format is a 16-bit floating point representation of data;
generating a first weight evaluation model by quantizing weights of the parametric layer of the base model into low precision format; and calculating an output of the first weight evaluation model, wherein the low precision format is an 8-bit integer representation of data;
calculating a first weight sensitivity value based on a difference between the output of the base model and the output of the first weight evaluation model;
generating a second weight evaluation model by quantizing weights of all previous layers to the parametric layer, of the base model, to low precision format;
calculating a second weight sensitivity value based on a difference between the output of the base model and the output of the second weight evaluation model; and
determining a mean of the first weight sensitivity value and the second weight sensitivity value as the weight sensitivity value of the parametric layer.

16. The method as claimed in claim 15, wherein for generating the union sensitivity list based on sensitivity values evaluated for the plurality of layers further comprises evaluating a feature sensitivity value for the parametric layer, the processor is configured to perform the steps of:
calculating an output of the parametric layer of the base model;
generating a first feature evaluation model by quantizing features and weights of layers, of the base model, from a previous parametric layer to the parametric layer into low precision format and calculating an output of the parametric layer of the first feature evaluation model;
calculating a first feature sensitivity value based on a difference between the output of the base model and the output of the first feature evaluation model;
generating a second feature evaluation model by quantizing weights and features of all previous layers till the parametric layer, of the base model, to low precision format;
calculating a second feature sensitivity value based on a difference between the output of the base model and the output of the second feature evaluation model; and
determining a mean of the first feature sensitivity value and the second feature sensitivity value as the feature sensitivity value of the parametric layer.

17. The system as claimed in claim 16, wherein for generating the union sensitivity list based on the sensitivity values evaluated for the plurality of layers, the processor is further configured to perform the steps of:
normalizing feature sensitivity values and weight sensitivity values corresponding to each parametric layer among the plurality of layers;
evaluating the score for each normalized value; and
generating the union sensitivity list of the scores evaluated for the normalized values;

18. The system as claimed in claim 17, wherein for evaluating the score for each normalized value, the processor is configured to evaluate a Z-score for each normalized value.

19. The system as claimed in claim 14, wherein for selecting the group of layers corresponding to the first set of sensitivity values, the processor is configured to perform the steps of:
clustering the sensitivity values based on the evaluated scores into a plurality of groups by:
clustering the first set of sensitivity values associated with scores of greater than or equal to a first threshold into a first group, wherein the first threshold is three times of a standard deviation of the scores;
clustering a second set of sensitivity values associated with scores of greater than a second threshold and less than the first threshold into a second group, wherein the second threshold is 2.5 times of the standard deviation;
clustering a third set of sensitivity values associated with scores of greater than a third threshold and less than the second threshold into a third group, wherein the third threshold is two times of the standard deviation; and
clustering the remaining sensitivity values as the fourth set of sensitivity values of the union sensitivity list into a fourth group.

20. The system as claimed in claim 6, the processor is further configured to perform the steps of:
for each sensitivity value of any of the first group, the second group, the third group,
i. determining each sensitivity value corresponds to at least one of a feature sensitivity value and a weight sensitivity value;
ii. upon determining that the sensitivity value corresponds to the weight sensitivity value of a layer, convert a weight and an input of the layer to high precision format; and
iii. upon determining that the sensitivity value corresponds to the feature sensitivity value of a layer, convert parameters of layers from a previous parametric layer to the parametric layer to high precision format.

21. The system as claimed in claim 6, wherein the processor is further configured to perform the steps of: for the fourth group of sensitivity values,
determining a layer corresponding to each sensitivity value;
evaluating a difference value of bits for the plurality of parametric layers;
sorting the layers based on the difference value of bits of each layer;
cluster the layers based on the difference values into a plurality of groups;
for each group of layers, sort the layers in a descending order of the corresponding sensitivity values; and
quantizing a layer of group into high precision format and perform the steps of e-g of claim 14.

22. The system as claimed in claim 21, wherein for evaluating the difference value of bits for the plurality of parametric layers, the processor is configured to perform the steps of:
evaluating a number of bits for each channel of the parametric layer; and
determining a difference between a maximum number of bits and a minimum number of bits for the parametric layer and storing the difference as the difference value of the layer.

23. The system as claimed in claim 14, wherein the processor is further configured to perform the steps of:
h. selecting a group of layers corresponding to a fourth set of sensitivity values;
i. generating another mixed precision quantization model by quantizing the selected group of layers into lower precision format;
j. computing a performance value of the another mixed precision quantization model for comparison with a target performance value;
k. in response to determining that the performance value of the another mixed precision quantization model is less than the target performance value, perform steps i to k; and
l. in response to determining that the performance value of the another mixed precision quantization model is greater than or equal to the target performance value, storing the another mixed precision quantization model as the final mixed precision quantization model for image processing.

24. The system as claimed in claim 23, wherein for selecting the group of layers corresponding to the fourth set of sensitivity values, the processor is configured to perform the steps of
clustering the sensitivity values based on the evaluated scores into another plurality of groups by:
clustering a fifth set of sensitivity values associated with scores of less than or equal to a fourth threshold into a fifth group, wherein the fourth threshold is a negative value of the first threshold;
clustering a sixth set of sensitivity values associated with scores of less than a fifth threshold and greater than the fourth threshold into a sixth group, wherein the fifth threshold is a negative value of the second threshold;
clustering a seventh set of sensitivity values associated with scores of less than a sixth threshold and greater than the fifth threshold into a seventh group, wherein the sixth threshold is a negative value of the third threshold; and
clustering the remaining sensitivity values as an eighth set of sensitivity values of the union sensitivity list into an eighth group.

25. The system as claimed in claim 24, wherein the processor is further configured to perform the steps of:
for each sensitivity value of any of the fifth group, the sixth group and the seventh group,
i. determining each sensitivity value corresponds to at least one of a feature sensitivity value and a weight sensitivity value;
ii. upon determining that the sensitivity value corresponds to the weight sensitivity value of a layer, convert a weight and an input of the layer to the lower precision format; and
iii. upon determining that the sensitivity value corresponds to the feature sensitivity value of a layer, convert parameters of layers from a previous parametric layer to the parametric layer to the lower precision format.
